(19) United States
(12) Patent Application Publication
(10) Pub. No.: US 2015/0028070 A1
(43) Pub. Date: Jan. 29, 2015

(54) Protective Case for Portable Electronic Device

(71) Applicants: Lisa Lambert, Newbury Park, CA (US); Robert N. Marcus, Tarzana, CA (US)

(72) Inventors: Lisa Lambert, Newbury Park, CA (US); Robert N. Marcus, Tarzana, CA (US)

(21) Appl. No.: 14/445,495

(22) Filed: Jul. 29, 2014

Related U.S. Application Data
(60) Provisional application No. 61/859,296, filed on Jul. 29, 2013.

(51) Int. Cl. G06F 1/16

(52) U.S. Cl. CPC G06F 1/1628
USPC 224/191

(57) ABSTRACT

The present specification discloses a protective case for a portable electronic device that protects the device from temperatures that can cause temporary malfunction or inoperation and/or permanent damage.

This U.S. Non-Provisional Patent Application claims priority pursuant to 35 U.S.C. §119(e) and is entitled to the filing date of U.S. Provisional Patent Application 61/859,296, filed Jul. 29, 2013, which is hereby incorporated by reference in its entirety.

### INTRODUCTION

Although designed to function in a variety of locations, environments and temperatures, portable electronic devices cannot handle extremely hot temperatures. Such temperature exposure will cause a portable electronic device to temporarily malfunction and/or become inoperable and/or cause permanent damage. For example, temperatures above 95° F. (35° C.) can cause the battery of a portable electronic device to overheat, resulting in power drainage, and in some cases of prolonged exposure, explosion due to volatility of the acids contained in the battery. Similarly, temperatures above 95° F. (35° C.) can cause overheating of the liquid inside a liquid crystal display (LCD) screen, resulting in the cracking and/or shattering of the screen. Thus, portable electronic devices have to be protected from extreme heat.

Conversely, portable electronic devices cannot handle extremely cold temperatures. Such temperatures will also cause a portable electronic device to temporarily malfunction and/or become inoperable and/or cause permanent damage. For example, temperatures below 32° F. (0° C.) can cause power drainage in the battery of a portable electronic device as well as freezing of the liquid inside a LCD screen, resulting in the cracking and/or shattering of the screen. Thus, portable electronic devices have to be protected from extreme cold.

However, given the portable nature of such electronic devices and the usefulness of having such devices with the user at all times, exposure to extreme heat is quite common. For example, many people will bring portable electronic devices with them to a hot weather outdoor activity or event, such as, e.g., swimming, a sporting event, a picnic, camping, hiking, or a concert. Yet it only takes about 25-30 minutes in direct heat on a day with high temperatures to cause permanent damage. In addition, a person may inadvertently leave a portable electronic device inside a vehicle, were temperatures can be 5° F. to 15° F. hotter than the outside ambient temperature. Lastly, many people will bring portable electronic devices with them to a winter outdoor activity or event, such as, e.g., skiing, snowboarding, ice skating, camping and hiking in the snow. Thus, what is needed is a portable protective case that can keep a portable electronic device from overheating or freezing, and thereby prevent malfunction, inoperation, or damage of the device.

### SUMMARY

Aspects of the present specification disclose a protective case for a portable electronic device. A protective case may comprise a plurality of compartments and a first securable opening. The plurality of compartment comprises three or more compartments. A first compartment of the plurality of compartment may comprise a front and a first divider, wherein the first divider and the front define a first interior space configured to contain a coolant material and/or a heating material; and wherein the first divider and the front comprise a water-resistant material. A second compartment of the plurality of compartment may comprise a back and a second divider, wherein the second divider and the back define a second interior space configured to contain a coolant material and/or a heating material; and wherein the second divider and the back comprise a water-resistant material. A third compartment of the plurality of compartment may comprise the first divider and the second divider, wherein the first divider and the second divider define a third interior space configured to contain a portable electronic device; and

Other aspects of the present specification disclose a protective case disclosed herein that may comprise a first compartment, a second compartment, a third compartment, and a first securable opening. A first compartment may comprise a front and a first divider, wherein the first divider and the front define a first interior space configured to contain a coolant material and/or a heating material; and wherein the first divider and the front comprise a water-resistant material. A second compartment may comprise a back and a second divider, wherein the second divider and the back define a second interior space configured to contain a coolant material and/or a heating material; and wherein the second divider and the back comprise a water-resistant material. A third compartment may comprise the first divider and the second divider, wherein the first divider and the second divider define a third interior space configured to contain a portable electronic device.

Yet other aspects of the present specification disclose a protective case disclosed herein that may comprise a divider that forms a first compartment and a second compartment. A first compartment disclosed herein may comprise a back and a first securable opening. In conjunction with a divider disclosed herein, a back and a first securable opening disclosed herein forms a first interior space configured to contain a coolant material and/or a heating material. A second compartment disclosed herein may comprise a front and a second securable opening. In conjunction with a divider disclosed herein, a front and a second securable opening disclosed herein forms a second interior space configured to contain a portable electronic device. A protective case disclosed herein may comprise a first compartment and one or more attachment points.

Still other aspects of the present specification disclose a kit comprising a protective case disclosed herein and a coolant material and/or a heating material and instructional material.

### BRIEF DESCRIPTION OF DRAWINGS

FIG. 1 illustrates various views of protective case 10 with FIG. 1A being a perspective view, FIG. 1B being a side view, FIG. 1C being a front view, and FIG. 1D being a cross-sectional view.

FIG. 2 illustrates various views of protective case 210 with FIG. 2A being a perspective view, FIG. 2B being a side view, FIG. 2C being a front view, and FIG. 2D being a cross-sectional view.

FIG. 3 illustrates a perspective view of protective case 310 showing external location of first securable opening 322 and second securable opening 324.

FIG. 4 illustrates a perspective view of protective case 410 showing external location of second securable opening 424 and internal location of first securable opening 422 second securable opening 424. Accessibility of the first securable opening 422 occurs only when the second securable opening 424 is open.

FIG. 5 illustrates a perspective view of protective case 510 showing single integrated securable opening 526.

FIG. 6 illustrates a perspective view of protective case 610 showing single integrated securable opening 626.

FIG. 7 illustrates various views of protective case 710 with FIG. 7A being a perspective view, FIG. 7B being a side view, FIG. 7C being a front view, and FIG. 7D being a cross-sectional view.

FIG. 8 illustrates various views of protective case 810 with FIG. 8A being a perspective view, FIG. 8B being a side view, FIG. 8C being a front view, and FIG. 8D being a cross-sectional view.

### DETAILED DESCRIPTION

A protective case disclosed herein is generally configured to bring a coolant material or heating material in close approximation with a portable electronic device in a manner keeps the portable electronic device from overheating. In some embodiments, the protective case is configured to comprise one compartment. In some embodiments, the protective case is configured to comprise two compartments, one for a coolant material and/or a heating material and the other for a portable electronic device. In some embodiments, the protective case is configured to comprise three compartments, two for a coolant material and/or a heating material and the third for a portable electronic device. In some embodiments, the protective case is configured to comprise plurality of compartments, two or more for a coolant material and/or a heating material and the other for a portable electronic device. In some embodiments, the protective case is configured to comprise a compartment for a coolant material and/or a heating material and an attachment mechanism. In these embodiments, the attachment mechanism is used to secure that protective case to a portable electronic device.

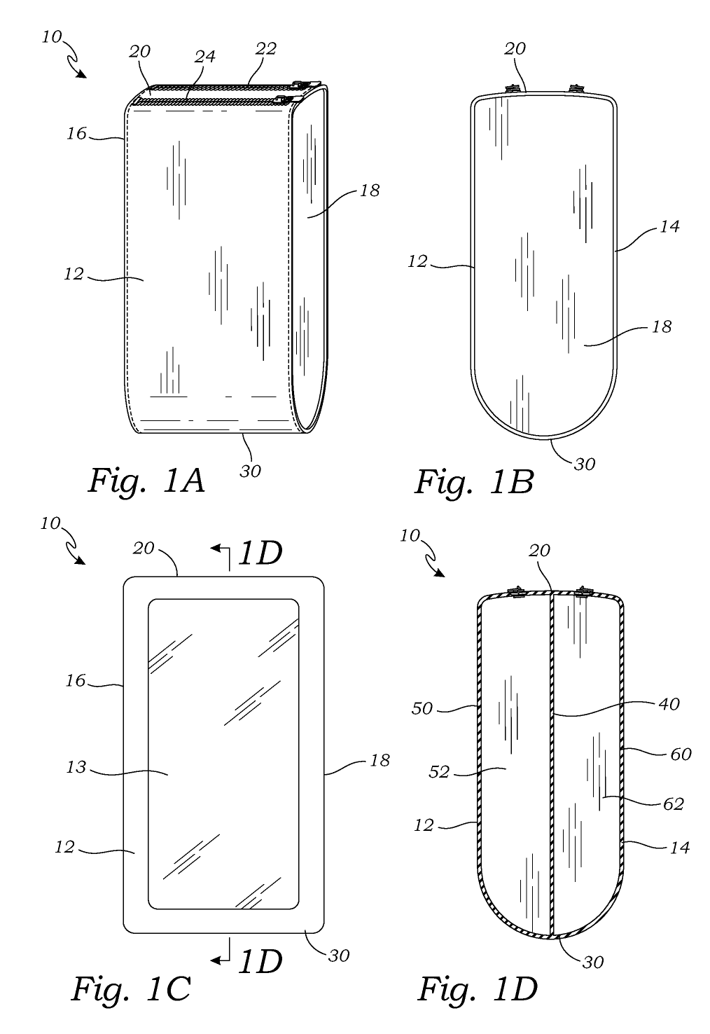

Thus, referring to FIG. 1, aspects of the present specification disclose protective case for a portable electronic device 10 comprising divider 40 that forms first compartment 50 including first interior space 52 and second compartment 60 including second interior space 62. In other aspects of the present specification, protective case for a portable electronic device 10 comprises front 12, back 14, first side 16, second side 18, and divider 40 that forms first compartment 50 including first interior space 52 and second compartment 60 including second interior space 62. In yet other aspects of the present specification, protective case for a portable electronic device comprises front 12, back 14, first side 16, second side 18, top 20 comprising first securable opening 22, second securable opening 24, bottom 30, and divider 40 that forms first compartment 50 including first interior space 52 and second compartment 60 including second interior space 62.

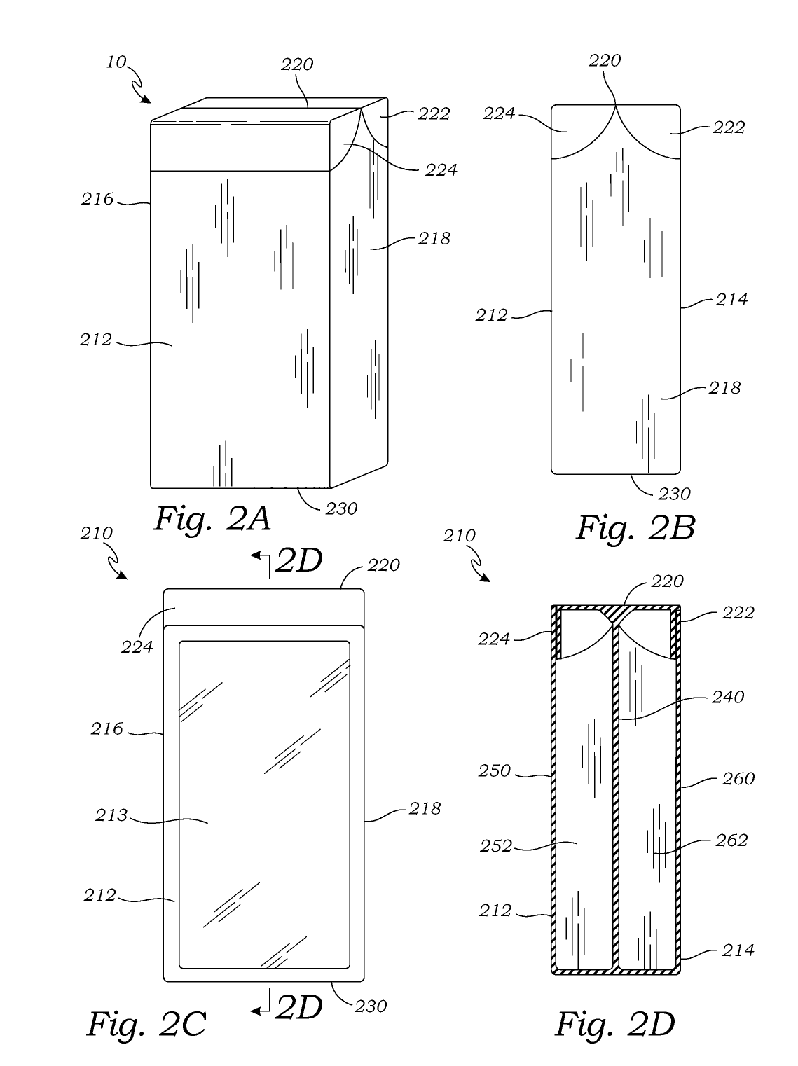

FIG. 2 shows aspects of the present specification disclose protective case for a portable electronic device 210 comprising divider 240 that forms first compartment 250 including first interior space 252 and second compartment 260 including second interior space 262. In other aspects of the present specification, protective case for a portable electronic device 210 comprises front 212, back 214, first side 216, second side 218, and divider 240 that forms first compartment 250 including first interior space 252 and second compartment 260 including second interior space 262. In yet other aspects of the present specification, protective case for a portable electronic device comprises front 212, back 214, first side 216, second side 218, top 220 comprising first securable opening 222, second securable opening 224, bottom 230, and divider 240 that forms first compartment 250 including first interior space 252 and second compartment 260 including second interior space 262.

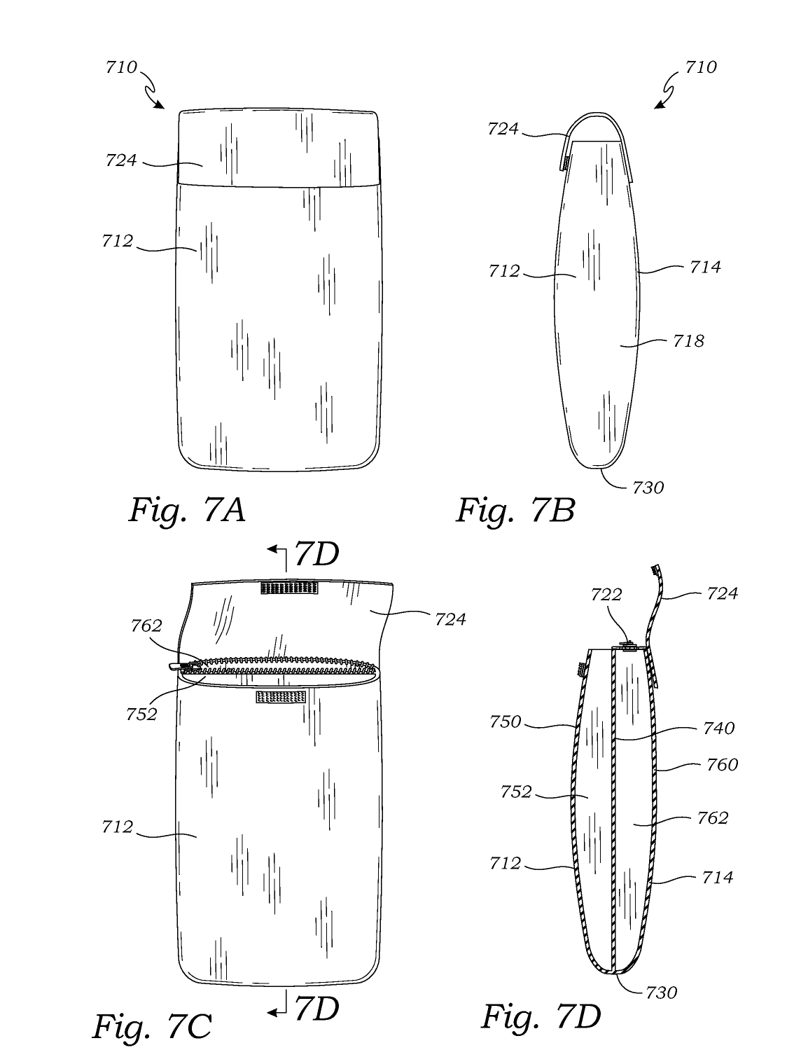

FIG. 7 shows aspects of the present specification disclose protective case for a portable electronic device 710 comprising divider 740 that forms first compartment 750 including first interior space 752 and second compartment 760 including second interior space 762. In other aspects of the present specification, protective case for a portable electronic device 710 comprises front 712, back 714, first side 716, second side 718, and divider 740 that forms first compartment 750 including first interior space 752 and second compartment 760 including second interior space 762. In yet other aspects of the present specification, protective case for a portable electronic device comprises front 712, back 714, first side 716, second side 718, top 720, bottom 730, divider 740 that forms first compartment 750 including first interior space 752 and second compartment 760 including second interior space 762, and securable opening 726 securing first compartment 750 and second compartment 760.

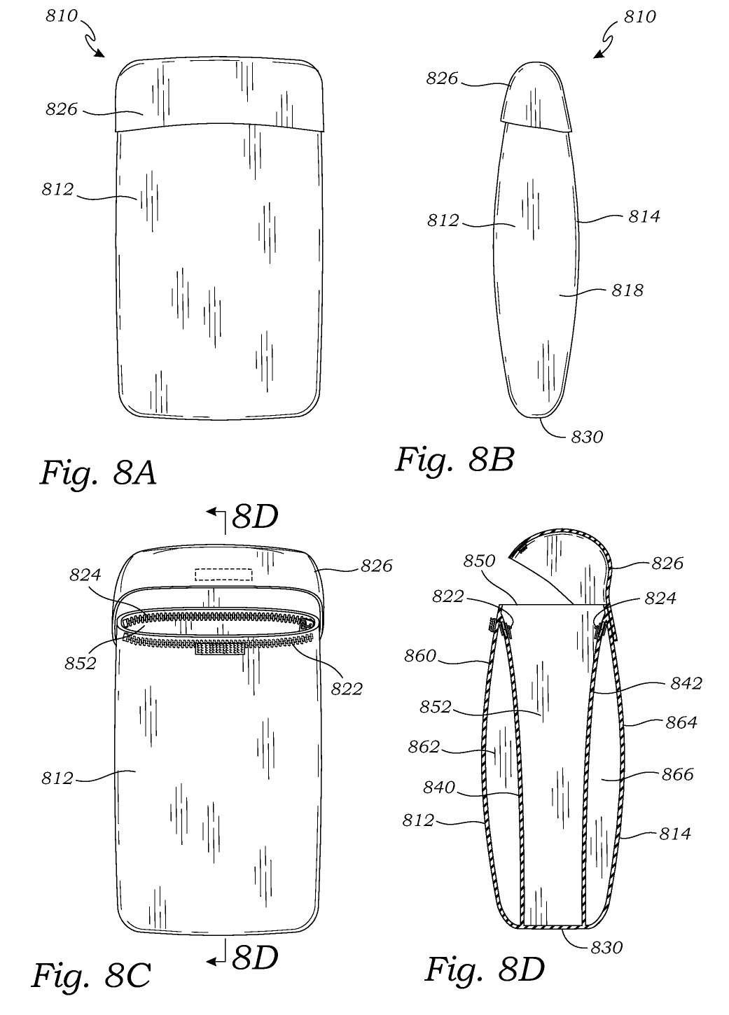

FIG. 8 shows aspects of the present specification disclose protective case for a portable electronic device 810 comprising a first divider 840 that forms first compartment 860 including first interior space 762, a second divider 842 that forms second compartment 864 including second interior space 766, where the first 840 and second 842 dividers form a third compartment 850 including third interior space 852. In other aspects of the present specification, protective case for a portable electronic device 810 comprises front 812, back 814, first side 816, second side 818, a first divider 840 that forms first compartment 860 including first interior space 762, a second divider 842 that forms second compartment 864 including first interior space 766, where the first 840 and second 842 dividers form a third compartment 850 including third interior space 852. In yet other aspects of the present specification, protective case for a portable electronic device comprises front 812, back 814, first side 816, second side 818, top 820, bottom 830, a first divider 840 that forms first compartment 860 including first interior space 762, a second divider 842 that forms second compartment 864 including first interior space 766, where the first 840 and second 842 dividers form a third compartment 850 including third interior space 852, and third securable opening 826 securing third compartment 850.

In some embodiments, a protective case disclosed herein may be proportioned to enable an electronic portable device to be inserted into the second compartment. Although for consistency, the present specification will refer to the first compartment as the compartment allowing containment of a coolant material and/or a heating material and the second compartment as the compartment allowing containment of an electronic portable device, the order can be switched, mutatis mutandis. In aspects of these embodiments, a protective case disclosed herein may have dimensions of, e.g., about 2.0 inches, about 2.5 inches, about 3.0 inches, about 3.5 inches, about 4.0 inches, about 4.5 inches, about 5.0 inches, about 5.5 inches, about 6.0 inches, about 6.5 inches, about 7.0 inches, about 7.5 inches, or about 8.0 inches in weight, about 4.5 inches, about 5.0 inches, about 5.5 inches, about 6.0 inches, about 6.5 inches, about 7.0 inches, about 7.5 inches, about 8.0 inches, about 8.5 inches, about 9.0 inches, about 9.5 inches, about 10.0 inches, about 10.5 inches, about 11.0 inches, about 11.5 inches, or about 12 inches in height, and about 0.5 inches, about 1.0 inches, about 1.5 inches, about 2.0 inches, about 2.5 inches, about 3.0 inches, about 3.5 inches, or about 4.0 inches in depth.

In other aspects of these embodiments, a protective case disclosed herein may have dimensions of, e.g., at least 2.0 inches, at least 2.5 inches, at least 3.0 inches, at least 3.5 inches, at least 4.0 inches, at least 4.5 inches, at least 5.0 inches, at least 5.5 inches, at least 6.0 inches, at least 6.5 inches, at least 7.0 inches, at least 7.5 inches, or at least 8.0 inches in weight, at least 4.5 inches, at least 5.0 inches, at least 5.5 inches, at least 6.0 inches, at least 6.5 inches, at least 7.0 inches, at least 7.5 inches, at least 8.0 inches, at least 8.5 inches, at least 9.0 inches, at least 9.5 inches, at least 10.0 inches, at least 10.5 inches, at least 11.0 inches, at least 11.5 inches, or at least 12 inches in height, and at least 0.5 inches, at least 1.0 inches, at least 1.5 inches, at least 2.0 inches, at least 2.5 inches, at least 3.0 inches, at least 3.5 inches, or at least 4.0 inches in depth.

In other aspects of these embodiments, a protective case disclosed herein may have dimensions of, e.g., at most 2.0 inches, at most 2.5 inches, at most 3.0 inches, at most 3.5 inches, at most 4.0 inches, at most 4.5 inches, at most 5.0 inches, at most 5.5 inches, at most 6.0 inches, at most 6.5 inches, at most 7.0 inches, at most 7.5 inches, or at most 8.0 inches in weight, at most 4.5 inches, at most 5.0 inches, at most 5.5 inches, at most 6.0 inches, at most 6.5 inches, at most 7.0 inches, at most 7.5 inches, at most 8.0 inches, at most 8.5 inches, at most 9.0 inches, at most 9.5 inches, at most 10.0 inches, at most 10.5 inches, at most 11.0 inches, at most 11.5 inches, or at most 12 inches in height, and at most 0.5 inches, at most 1.0 inches, at most 1.5 inches, at most 2.0 inches, at most 2.5 inches, at most 3.0 inches, at most 3.5 inches, or at most 4.0 inches in depth.

In another aspect of these embodiments, a protective case disclosed herein may have dimensions of, e.g., about 2.0 inches to about 4.0 inches in width, about 4.0 inches to about 6.0 inches in height, and about 0.5 inches to about 1.5 inches in depth. In yet another aspect of these embodiments, a protective case disclosed herein may have dimensions of, e.g., about 2.0 inches to about 3.0 inches in width, about 4.5 inches to about 5.5 inches in height, and about 0.5 inches to about 1.0 inches in depth.

In another aspect of these embodiments, a protective case disclosed herein may have dimensions of, e.g., about 3.0 inches to about 5.0 inches in width, about 5.0 inches to about 7.0 inches in height, and about 0.5 inches to about 1.5 inches in depth. In yet another aspect of these embodiments, a protective case disclosed herein may have dimensions of, e.g., about 3.5 inches to about 4.5 inches in width, about 5.5 inches to about 6.5 inches in height, and about 0.5 inches to about 1.0 inches in depth.

In another aspect of these embodiments, a protective case disclosed herein may have dimensions of, e.g., about 4.0 inches to about 6.0 inches in width, about 6.0 inches to about 8.0 inches in height, and about 0.5 inches to about 1.5 inches in depth. In yet another aspect of these embodiments, a protective case disclosed herein may have dimensions of, e.g., about 4.5 inches to about 5.5 inches in width, about 6.5 inches to about 7.5 inches in height, and about 0.5 inches to about 1.25 inches in depth.

In another aspect of these embodiments, a protective case disclosed herein may have dimensions of, e.g., about 5.0 inches to about 7.0 inches in width, about 7.0 inches to about 9.0 inches in height, and about 0.5 inches to about 1.5 inches in depth. In yet another aspect of these embodiments, a protective case disclosed herein may have dimensions of, e.g., about 5.5 inches to about 6.5 inches in width, about 7.5 inches to about 8.5 inches in height, and about 0.5 inches to about 1.25 inches in depth.

In another aspect of these embodiments, a protective case disclosed herein may have dimensions of, e.g., about 6.0 inches to about 8.0 inches in width, about 8.0 inches to about 10.0 inches in height, and about 0.5 inches to about 1.5 inches in depth. In yet another aspect of these embodiments, a protective case disclosed herein may have dimensions of, e.g., about 6.5 inches to about 7.5 inches in width, about 8.5 inches to about 9.5 inches in height, and about 0.5 inches to about 1.25 inches in depth.

In another aspect of these embodiments, a protective case disclosed herein may have dimensions of, e.g., about 7.0 inches to about 9.0 inches in width, about 9.0 inches to about 11.0 inches in height, and about 0.5 inches to about 2.0 inches in depth. In yet another aspect of these embodiments, a protective case disclosed herein may have dimensions of, e.g., about 7.5 inches to about 8.5 inches in width, about 9.5 inches to about 10.5 inches in height, and about 0.5 inches to about 1.5 inches in depth.

In another aspect of these embodiments, a protective case disclosed herein may have dimensions of, e.g., about 8.0 inches to about 10.0 inches in width, about 10.0 inches to about 14.0 inches in height, and about 0.5 inches to about 2.0 inches in depth. In yet another aspect of these embodiments, a protective case disclosed herein may have dimensions of, e.g., about 8.5 inches to about 9.5 inches in width, about 11.0 inches to about 13.0 inches in height, and about 0.5 inches to about 1.5 inches in depth.

The present specification discloses, in part, a divider. A divider may be used to separate a compartment for a coolant material and/or a heating material from a compartment for the portable electronic device. In one embodiment, a protective case may comprise a single divider, see, e.g., FIG. 1, divider 40, FIG. 2, divider 240, FIG. 7, divider 740. In another embodiment, a protective case may comprise a plurality of dividers, see, e.g., FIG. 8, first divider 840 and second divider 842. In aspects of this embodiment, a protective case may comprise, e.g., 1, 2, 3, 4, 5, 6, 7, 8, 9, or 10 dividers. In other aspects of this embodiment, a protective case may comprise, e.g., at least 1, at least 2, at least 3, at least 4, at least 5, at least 6, at least 7, at least 8, at least 9, or at least 10 dividers. In yet other aspects of this embodiment, a protective case may comprise, e.g., at most 1, at most 2, at most 3, at most 4, at most 5, at most 6, at most 7, at most 8, at most 9, or at most 10 dividers. In yet other aspects of this embodiment, a protective case may comprise, e.g., about 1 to about 2 dividers, about 1 to about 3 dividers, about 1 to about 4 dividers, about 1 to about 5 dividers, about 1 to about 6 dividers, about 1 to about 7 dividers, about 1 to about 8 dividers, about 1 to about 9 dividers, about 1 to about 10 dividers, about 2 to about 3 dividers, about 2 to about 4 dividers, about 2 to about 5 dividers, about 2 to about 6 dividers, about 2 to about 7 dividers, about 2 to about 8 dividers, about 2 to about 9 dividers, about 2 to about 10 dividers, about 3 to about 4 dividers, about 3 to about 5 dividers, about 3 to about 6 dividers, about 3 to about 7 dividers, about 3 to about 8 dividers, about 3 to about 9 dividers, about 3 to about 10 dividers, about 4 to about 5 dividers, about 4 to about 6 dividers, about 4 to about 7 dividers, about 4 to about 8 dividers, about 4 to about 9 dividers, about 4 to about 10 dividers, about 5 to about 6 dividers, about 5 to about 7 dividers, about 5 to about 8 dividers, about 5 to about 9 dividers, about 5 to about 10 dividers, about 6 to about 7 dividers, about 6 to about 8 dividers, about 6 to about 9 dividers, or about 6 to about 10 dividers.

In some embodiments, a divider disclosed herein comprises a material that effectively transfers thermal energy from a lower temperature to a higher temperature. In other embodiment, a divider disclosed herein comprises a non-thermal conductive material. Thermal conductivity is the property of a material to conduct thermal energy. Thermal transfer occurs at a higher rate across materials of high thermal conductivity than across materials of low thermal conductivity. In aspects of this embodiment, a divider may comprise any material that has a high thermal conductivity. In other aspects of this embodiment, a divider may comprise any material that can function as a heat sink. In an aspects of this embodiment, the conductive material may be, e.g., graphene, metal or a metal alloy such as, e.g., lead and its alloys, stainless steel and its alloys, copper and its alloys, aluminum and its alloys, gold and its alloys, and silver and its alloys.

A thermal conductance is the quantity of heat that passes in unit time through a plate of particular area and thickness when its opposite faces differ in temperature by one kelvin. For a plate of thermal conductivity k, area A and thickness L, the conductance calculated is kA/L, measured in W/mK (equivalent to: W/° C.). The thermal conductance of that particular construction is the inverse of the thermal resistance. In aspect of this embodiment, a divider comprises a material having a thermal conductivity of, e.g., 0.1 W/mK or more, 0.25 W/mK or more, 0.5 W/mK or more, 0.75 W/mK or more, 1 W/mK or more, 2.5 W/mK or more, 5 W/mK or more, 7.5 W/mK or more, 10 W/mK or more, 25 W/mK or more, 50 W/mK or more, 75 W/mK or more, 100 W/mK or more, 200 W/mK or more, 300 W/mK or more, 400 W/mK or more, 500 W/mK or more, 600 W/mK or more, 700 W/mK or more, 800 W/mK or more, 900 W/mK or more, 1,000 W/mK or more, 1,000 W/mK or more, 1,100 W/mK or more, 1,200 W/mK or more, 1,300 W/mK or more, 1,400 W/mK or more, 1,500 W/mK or more, 1,600 W/mK or more, 1,700 W/mK or more, 1,800 W/mK or more, 1,900 W/mK or more, or 2,000 W/mK or more. In other aspects of this embodiments, a divider comprises a material having a thermal conductivity in the range of, e.g., about 0.01 W/mk to about 1,000 W/mk, about 0.1 W/mk to about 1,000 W/mk, about 1 W/mk to about 1,000 W/mk, about 10 W/mk to about 1,000 W/mk, about 100 W/mk to about 1,000 W/mk, about 200 W/mk to about 1,000 W/mk, about 300 W/mk to about 1,000 W/mk, about 400 W/mk to about 1,000 W/mk, about 500 W/mk to about 1,000 W/mk, about 0.01 W/mk to about 1,500 W/mk, about 0.1 W/mk to about 1,500 W/mk, about 1 W/mk to about 1,500 W/mk, about 10 W/mk to about 1,500 W/mk, about 100 W/mk to about 1,500 W/mk, about 200 W/mk to about 1,500 W/mk, about 300 W/mk to about 1,500 W/mk, about 400 W/mk to about 1,500 W/mk, about 500 W/mk to about 1,500 W/mk, about 0.01 W/mk to about 2,000 W/mk, about 0.1 W/mk to about 2,000 W/mk, about 1 W/mk to about 2,000 W/mk, about 10 W/mk to about 2,000 W/mk, about 100 W/mk to about 2,000 W/mk, about 200 W/mk to about 2,000 W/mk, about 300 W/mk to about 2,000 W/mk, about 400 W/mk to about 2,000 W/mk, or about 500 W/mk to about 2,000 W/mk.

A heat transfer coefficient is the quantity of heat that passes in unit time through unit area of a plate of particular thickness when its opposite faces differ in temperature by one kelvin. For heat transfer coefficient k, area A and thickness L, the transfer coefficient calculated is kIL, measured in W/Km². The heat transfer coefficient of that particular construction is the inverse of the thermal insulation. In an embodiment, a divider disclosed herein comprises a material having a high heat transfer coefficient. In aspect of this embodiment, a divider disclosed herein comprises a material having a heat transfer coefficient of, e.g., 0.1 W/Km² or more, 0.5 W/Km² or more, 0.75 W/Km² or more, 1 W/Km² or more, 2.5 W/Km² or more, 5 W/Km² or more, 7.5 W/Km² or more, 10 W/Km² or more, 25 W/Km² or more, 50 W/Km² or more, 75 W/Km² or more, 100 W/Km² or more, 200 W/Km² or more, 300 W/Km² or more, 400 W/Km² or more, 500 W/Km² or more, 600 W/Km² or more, 700 W/Km² or more, 800 W/Km² or more, 900 W/Km² or more, 1,000 W/Km² or more, 1,000 W/Km² or more, 1,100 W/Km² or more, 1,200 W/Km² or more, 1,300 W/Km² or more, 1,400 W/Km² or more, 1,500 W/Km² or more, 1,600 W/Km² or more, 1,700 W/Km² or more, 1,800 W/Km² or more, 1,900 W/Km² or more, or 2,000 W/Km² or more. In other aspects of this embodiments, a divider disclosed herein comprises a material having a heat transfer coefficient in the range of, e.g., about 0.01 W/Km² to about 1,000 W/Km², about 0.1 W/Km² to about 1,000 W/Km², about 1 W/Km² to about 1,000 W/Km², about 10 W/Km² to about 1,000 W/Km², about 100 W/Km² to about 1,000 W/Km², about 200 W/Km² to about 1,000 W/Km², about 300 W/Km² to about 1,000 W/Km², about 400 W/Km² to about 1,000 W/Km², about 500 W/Km² to about 1,000 W/Km², about 0.01 W/Km² to about 1,500 W/Km², about 0.1 W/Km² to about 1,500 W/Km², about 1 W/Km² to about 1,500 W/Km², about 10 W/Km² to about 1,500 W/Km², about 100 W/Km² to about 1,500 W/Km², about 200 W/Km² to about 1,500 W/Km², about 300 W/Km² to about 1,500 W/Km², about 400 W/Km² to about 1,500 W/Km², about 500 W/Km² to about 1,500 W/Km², about 0.01 W/Km² to about 2,000 W/Km², about 0.1 W/Km² to about 2,000 W/Km², about 1 W/Km² to about 2,000 W/Km², about 10 W/Km² to about 2,000 W/Km², about 100 W/Km² to about 2,000 W/Km², about 200 W/Km² to about 2,000 W/Km², about 300 W/Km² to about 2,000 W/Km², about 400 W/Km² to about 2,000 W/Km², or about 500 W/Km² to about 2,000 W/Km².

A divider disclosed herein may further comprise a thermal material that can be maintained at temperature sufficient to keep a portable electronic device from overheating to a temperature that can cause device malfunction, inoperation and/or damage or from freezing to a temperature that can cause device malfunction, inoperation and/or damage. A thermal material disclosed herein redirects heat generated by the environment away from a compartment containing a portable electronic device in conditions where the device requires low temperatures for proper functionality, such as, e.g., conditions of extreme heat and/or contains heat generated by a portable electronic device within the compartment containing the device in conditions where the device requires higher temperatures for proper functionality, such as, e.g., conditions of extreme cold. A thermal material may be placed on the inside surface of a divider (surface facing the compartment comprising a coolant material and/or a heating material), within the divider or on the outside surface of a divider (surface facing the compartment comprising the portable electronic device).

In aspects of this embodiment, a thermal material may maintain a temperature of, e.g., 30° C. or lower, 28° C. or lower, 26° C. or lower, 24° C. or lower, 22° C. or lower, 20° C. or lower, 18° C. or lower, 16° C. or lower, 14° C. or lower, 12° C. or lower, 10° C. or lower, 8° C. or lower, 6° C. or lower, 4° C. or lower, 2° C. or lower, or 0° C. or lower, for a time of, e.g., at least 60 minutes, at least 90 minutes, at least 120 minutes, at least 150 minutes, at least 180 minutes, at least 210 minutes, at least 240 minutes, at least 300 minutes, at least 330 minutes, or at least 360 minutes. In other aspects of this embodiment, a thermal material may maintain a temperature of, e.g., 0° C. or higher, 2° C. or higher, 4° C. or higher, 6° C. or higher, 8° C. or higher, 10° C. or higher, 12° C. or higher, 14° C. or higher, 16° C. or higher, 18° C. or higher, 20° C. or higher, 22° C. or higher, 24° C. or higher, 26° C. or higher, 28° C. or higher, or 30° C. or higher, for a time of, e.g., at least 60 minutes, at least 90 minutes, at least 120 minutes, at least 150 minutes, at least 180 minutes, at least 210 minutes, at least 240 minutes, at least 300 minutes, at least 330 minutes, or at least 360 minutes.

In yet other aspects, a thermal material may maintain a temperature range of, e.g., about 0° C. to about 4° C., about 0° C. to about 6° C., about 0° C. to about 8° C., about 0° C. to about 10° C., about 0° C. to about 12° C., about 2° C. to about 6° C., about 2° C. to about 8° C., about 2° C. to about 10° C., about 2° C. to about 12° C., about 2° C. to about 14° C., about 4° C. to about 8° C., about 4° C. to about 10° C., about 4° C. to about 12° C., about 4° C. to about 14° C., about 4° C. to about 16° C., about 4° C. to about 18° C., about 4° C. to about 20° C., about 4° C. to about 22° C., about 4° C. to about 24° C., about 4° C. to about 26° C., about 4° C. to about 28° C., about 4° C. to about 30° C., about 8° C. to about 12° C., about 8° C. to about 14° C., about 8° C. to about 16° C., about 8° C. to about 18° C., about 8° C. to about 20° C., about 8° C. to about 22° C., about 8° C. to about 24° C., about 8° C. to about 26° C., about 8° C. to about 28° C., about 8° C. to about 30° C., about 12° C. to about 16° C., about 12° C. to about 18° C., about 12° C. to about 20° C., about 12° C. to about 22° C., about 12° C. to about 24° C., about 12° C. to about 26° C., about 12° C. to about 28° C., about 12° C. to about 30° C., about 14° C. to about 16° C., about 14° C. to about 18° C., about 14° C. to about 20° C., about 14° C. to about 22° C., about 14° C. to about 24° C., about 14° C. to about 26° C., about 14° C. to about 28° C., about 14° C. to about 30° C., about 16° C. to about 16° C., about 16° C. to about 18° C., about 16° C. to about 20° C., about 16° C. to about 22° C., about 16° C. to about 24° C., about 16° C. to about 26° C., about 16° C. to about 28° C., or about 16° C. to about 30° C., for a time range of, e.g., about 60 minutes to about 120 minutes, about 60 minutes to about 180 minutes, about 60 minutes to about 240 minutes, about 60 minutes to about 300 minutes, or about 60 minutes to about 360 minutes.

The present specification discloses, in part a compartment for a portable electronic device. Non-limiting examples of a portable electronic device include a personal digital assistant (PDAs), a smartphone, a mobile phone, a satellite phone, a cellular phone, a tablet, a computer, a pager, a music player, a MP3 player, a media player, a digital camera, a video camera, a bar code scanner, a global positioning system (GPS), and a portable game console.

In one embodiment, a protective case may comprise a single compartment for a portable electronic device, see, e.g., FIG. 1, compartment 50, FIG. 2, compartment 250, FIG. 7, compartment 750, or FIG. 8, compartment 850. In another embodiment, a protective case may comprise a plurality of compartments for a portable electronic device. In aspects of this embodiment, a protective case may comprise, e.g., 1, 2, 3, or 4 compartments for a portable electronic device. In other aspects of this embodiment, a protective case may comprise, e.g., at least 1, at least 2, at least 3, or at least 4, compartments for a portable electronic device. In yet other aspects of this embodiment, a protective case may comprise, e.g., at most 1, at most 2, at most 3, or at most 4, compartments for a portable electronic device. In yet other aspects of this embodiment, a protective case may comprise, e.g., about 1 to about 2 compartments, about 1 to about 3 compartments, about 1 to about 4 compartments, about 2 to about 3 compartments, about 2 to about 4 compartments, or about 3 to about 4 compartments for a portable electronic device.

The present specification discloses, in part a compartment for a coolant material and/or a heating material. In one embodiment, a protective case may comprise a single compartment for a coolant material and/or a heating material, see, e.g., FIG. 1, compartment 60, FIG. 2, compartment 260, FIG. 7, compartment 760. In another embodiment, a protective case may comprise a plurality of compartments for a coolant material and/or a heating material, see, e.g., FIG. 8, first compartment for a coolant material and/or a heating material 860 and second compartment for a coolant material and/or a heating material 864. In aspects of this embodiment, a protective case may comprise, e.g., 1, 2, 3, 4, 5, 6, 7, 8, 9, or 10 compartments for a coolant material and/or a heating material. In other aspects of this embodiment, a protective case may comprise, e.g., at least 1, at least 2, at least 3, at least 4, at least 5, at least 6, at least 7, at least 8, at least 9, or at least 10 compartments for a coolant material and/or a heating material. In yet other aspects of this embodiment, a protective case may comprise, e.g., at most 1, at most 2, at most 3, at most 4, at most 5, at most 6, at most 7, at most 8, at most 9, or at most 10 compartments for a coolant material and/or a heating material. In yet other aspects of this embodiment, a protective case may comprise, e.g., about 1 to about 2 compartments, about 1 to about 3 compartments, about 1 to about 4 compartments, about 1 to about 5 compartments, about 1 to about 6 compartments, about 1 to about 7 compartments, about 1 to about 8 compartments, about 1 to about 9 compartments, about 1 to about 10 compartments, about 2 to about 3 compartments, about 2 to about 4 compartments, about 2 to about 5 compartments, about 2 to about 6 compartments, about 2 to about 7 compartments, about 2 to about 8 compartments, about 2 to about 9 compartments, about 2 to about 10 compartments, about 3 to about 4 compartments, about 3 to about 5 compartments, about 3 to about 6 compartments, about 3 to about 7 compartments, about 3 to about 8 compartments, about 3 to about 9 compartments, about 3 to about 10 compartments, about 4 to about 5 compartments, about 4 to about 6 compartments, about 4 to about 7 compartments, about 4 to about 8 compartments, about 4 to about 9 compartments, about 4 to about 10 compartments, about 5 to about 6 compartments, about 5 to about 7 compartments, about 5 to about 8 compartments, about 5 to about 9 compartments, about 5 to about 10 compartments, about 6 to about 7 compartments, about 6 to about 8 compartments, about 6 to about 9 compartments, or about 6 to about 10 compartments for a coolant material and/or a heating material.

The present specification discloses, in part a compartment for a coolant material. A coolant material is any material that can be maintained at temperature sufficient to keep a portable electronic device from overheating to a temperature that causes device malfunction, inoperation and/or damage. In aspects of this embodiment, a coolant material may maintain a temperature of, e.g., 30° C. or lower, 28° C. or lower, 26° C. or lower, 24° C. or lower, 22° C. or lower, 20° C. or lower, 18° C. or lower, 16° C. or lower, 14° C. or lower, 12° C. or lower, 10° C. or lower, 8° C. or lower, 6° C. or lower, 4° C. or lower, 2° C. or lower, or 0° C. or lower, for a time of, e.g., at least 60 minutes, at least 90 minutes, at least 120 minutes, at least 150 minutes, at least 180 minutes, at least 210 minutes, at least 240 minutes, at least 300 minutes, at least 330 minutes, or at least 360 minutes. In other aspects of this embodiment, a coolant material may maintain a temperature of, e.g., 0° C. or higher, 2° C. or higher, 4° C. or higher, 6° C. or higher, 8° C. or higher, 10° C. or higher, 12° C. or higher, 14° C. or higher, 16° C. or higher, 18° C. or higher, 20° C. or higher, 22° C. or higher, 24° C. or higher, 26° C. or higher, 28° C. or higher, or 30° C. or higher, for a time of, e.g., at least 60 minutes, at least 90 minutes, at least 120 minutes, at least 150 minutes, at least 180 minutes, at least 210 minutes, at least 240 minutes, at least 300 minutes, at least 330 minutes, or at least 360 minutes.

In yet other aspects, a coolant material may maintain a temperature range of, e.g., about 0° C. to about 4° C., about 0° C. to about 6° C., about 0° C. to about 8° C., about 0° C. to about 10° C., about 0° C. to about 12° C., about 2° C. to about 6° C., about 2° C. to about 8° C., about 2° C. to about 10° C., about 2° C. to about 12° C., about 2° C. to about 14° C., about 4° C. to about 8° C., about 4° C. to about 10° C., about 4° C. to about 12° C., about 4° C. to about 14° C., about 4° C. to about 16° C., about 4° C. to about 18° C., about 4° C. to about 20° C., about 4° C. to about 22° C., about 4° C. to about 24° C., about 4° C. to about 26° C., about 4° C. to about 28° C., about 4° C. to about 30° C., about 8° C. to about 12° C., about 8° C. to about 14° C., about 8° C. to about 16° C., about 8° C. to about 18° C., about 8° C. to about 20° C., about 8° C. to about 22° C., about 8° C. to about 24° C., about 8° C. to about 26° C., about 8° C. to about 28° C., about 8° C. to about 30° C., about 12° C. to about 16° C., about 12° C. to about 18° C., about 12° C. to about 20° C., about 12° C. to about 22° C., about 12° C. to about 24° C., about 12° C. to about 26° C., about 12° C. to about 28° C., about 12° C. to about 30° C., about 14° C. to about 16° C., about 14° C. to about 18° C., about 14° C. to about 20° C., about 14° C. to about 22° C., about 14° C. to about 24° C., about 14° C. to about 26° C., about 14° C. to about 28° C., about 14° C. to about 30° C., about 16° C. to about 16° C., about 16° C. to about 18° C., about 16° C. to about 20° C., about 16° C. to about 22° C., about 16° C. to about 24° C., about 16° C. to about 26° C., about 16° C. to about 28° C., or about 16° C. to about 30° C., for a time range of, e.g., about 60 minutes to about 120 minutes, about 60 minutes to about 180 minutes, about 60 minutes to about 240 minutes, about 60 minutes to about 300 minutes, or about 60 minutes to about 360 minutes.

In some embodiments, a coolant material disclosed herein may be an activatible coolant material or a non-activatible coolant material. An activatible coolant material is a material that becomes a coolant material only after an activation process is initiated. A non-limiting example of an activatible coolant material is a material that undergoes an endothermic reaction only after a chemical process is initiated in the material itself like an instant ice pack or a cool pack. A non-activatible coolant material is a material requires a freezing process for it to become a coolant material. A non-limiting example of a non-activatible coolant material is an ice pack, gel pack, or similar material that requires freezing for the material to become a coolant material.

The present specification discloses, in part a compartment for a heating material. A heating material is any material that can be maintained at temperature sufficient to keep a portable electronic device from cooling to a temperature that causes device malfunction, inoperation and/or damage. In aspects of this embodiment, a heating material may maintain a temperature of, e.g., 30° C. or lower, 28° C. or lower, 26° C. or lower, 24° C. or lower, 22° C. or lower, 20° C. or lower, 18° C. or lower, 16° C. or lower, 14° C. or lower, 12° C. or lower, 10° C. or lower, 8° C. or lower, 6° C. or lower, 4° C. or lower, 2° C. or lower, or 0° C. or lower, for a time of, e.g., at least 60 minutes, at least 90 minutes, at least 120 minutes, at least 150 minutes, at least 180 minutes, at least 210 minutes, at least 240 minutes, at least 300 minutes, at least 330 minutes, or at least 360 minutes. In other aspects of this embodiment, a heating material may maintain a temperature of, e.g., 0° C. or higher, 2° C. or higher, 4° C. or higher, 6° C. or higher, 8° C. or higher, 10° C. or higher, 12° C. or higher, 14° C. or higher, 16° C. or higher, 18° C. or higher, 20° C. or higher, 22° C. or higher, 24° C. or higher, 26° C. or higher, 28° C. or higher, or 30° C. or higher, for a time of, e.g., at least 60 minutes, at least 90 minutes, at least 120 minutes, at least 150 minutes, at least 180 minutes, at least 210 minutes, at least 240 minutes, at least 300 minutes, at least 330 minutes, or at least 360 minutes.

In yet other aspects, a heating material may maintain a temperature range of, e.g., about 0° C. to about 4° C., about 0° C. to about 6° C., about 0° C. to about 8° C., about 0° C. to about 10° C., about 0° C. to about 12° C., about 2° C. to about 6° C., about 2° C. to about 8° C., about 2° C. to about 10° C., about 2° C. to about 12° C., about 2° C. to about 14° C., about 4° C. to about 8° C., about 4° C. to about 10° C., about 4° C. to about 12° C., about 4° C. to about 14° C., about 4° C. to about 16° C., about 4° C. to about 18° C., about 4° C. to about 20° C., about 4° C. to about 22° C., about 4° C. to about 24° C., about 4° C. to about 26° C., about 4° C. to about 28° C., about 4° C. to about 30° C., about 8° C. to about 12° C., about 8° C. to about 14° C., about 8° C. to about 16° C., about 8° C. to about 18° C., about 8° C. to about 20° C., about 8° C. to about 22° C., about 8° C. to about 24° C., about 8° C. to about 26° C., about 8° C. to about 28° C., about 8° C. to about 30° C., about 12° C. to about 16° C., about 12° C. to about 18° C., about 12° C. to about 20° C., about 12° C. to about 22° C., about 12° C. to about 24° C., about 12° C. to about 26° C., about 12° C. to about 28° C., about 12° C. to about 30° C., about 14° C. to about 16° C., about 14° C. to about 18° C., about 14° C. to about 20° C., about 14° C. to about 22° C., about 14° C. to about 24° C., about 14° C. to about 26° C., about 14° C. to about 28° C., about 14° C. to about 30° C., about 16° C. to about 16° C., about 16° C. to about 18° C., about 16° C. to about 20° C., about 16° C. to about 22° C., about 16° C. to about 24° C., about 16° C. to about 26° C., about 16° C. to about 28° C., or about 16° C. to about 30° C., for a time range of, e.g., about 60 minutes to about 120 minutes, about 60 minutes to about 180 minutes, about 60 minutes to about 240 minutes, about 60 minutes to about 300 minutes, or about 60 minutes to about 360 minutes.

In some embodiments, a heating material disclosed herein may be an activatible heating material or a non-activatible heating material. An activatible heating material is a material that becomes a heat material only after an activation process is initiated. A non-limiting example of an activatible heating material is a material that undergoes an exothermic reaction only after a chemical process is initiated in the material itself like a heat pack. A non-activatible heating material is a material requires a heating process for it to become a heat material. A non-limiting example of a non-activatible heating material is an heat pack, gel pack, or similar material that requires heating, e.g., microradiation, boiling water, for the material to become a heat material.

Aspects of the present specification disclose, in part, an interior space. An interior space is configured to contain a coolant material disclosed herein, a heating material disclosed herein, or a portable electronic device disclosed herein. In some embodiment, an interior space can be defined by a divider and a front disclosed herein, see, e.g., FIG. 1, interior space 52, FIG. 2, interior space 252, FIG. 7, interior space 752, or FIG. 8, interior space 862. In some embodiments, an interior space can be defined a divider and a back disclosed herein, see, e.g., FIG. 1, interior space 62, FIG. 2, interior space 262, FIG. 7, interior space 762, or FIG. 8, interior space 866. In some embodiments, an interior space can be defined by a first and second divider disclosed herein, see, e.g., FIG. 8, interior space 852.

In some embodiments, a compartment for a coolant material or heating material disclosed herein comprises a back, where a divider and a back define an interior space. In some embodiments, a compartment for a coolant material or heating material disclosed herein comprises a back and a securable opening, where a divider, a back and a securable opening define an interior space, see, e.g. FIG. 1, interior space 62, FIG. 7, interior space 766, and FIG. 8, second interior space 866. In some embodiments, a compartment for a coolant material or heating material disclosed herein comprises a back and an unsecurable opening, where a divider, a back and an unsecurable opening define an interior space. In some embodiments, a compartment for a coolant material or heating material disclosed herein comprises a front and a securable opening, where a divider, a back and a securable opening define an interior space, see, e.g. FIG. 8, first interior space 862. In some embodiments, a compartment for a coolant material or heating material disclosed herein comprises a front and an unsecurable opening, where a divider, a back and an unsecurable opening define an interior space.

In some embodiments, a compartment for a portable electronic device disclosed herein comprises a front, where a divider and a front define an interior space, see, e.g. FIG. 7, interior space 752. In some embodiments, a compartment for a portable electronic device disclosed herein comprises a front and a securable opening, where a divider, a front and a securable opening define an interior space, see, e.g. FIG. 1, interior space 52, or FIG. 2, interior space 252. In some embodiments, a compartment for a portable electronic device disclosed herein comprises a front and an unsecurable opening, where a divider, a front and an unsecurable opening define an interior space. In some embodiments, an interior space for a portable electronic device disclosed herein can be defined by a first and second divider disclosed herein, see, e.g., FIG. 8, interior space 852.

Aspects of the present application disclose an unsecurable opening. An unsecurable opening enables access to an interior space disclosed herein, but does not provide a mechanism for a user to close or seal the interior space. Thus, a user can insert or remove a coolant material, a heating material, and/or a portable electronic device from an interior space without having to open this space in order to insert or remove the item. In one embodiment, a protective case may comprise a single unsecurable opening. In another embodiment, a protective case may comprise a plurality of unsecurable openings. In aspects of this embodiment, a protective case may comprise, e.g., 1, 2, 3, 4, 5, 6, 7, 8, 9, or 10 unsecurable openings. In other aspects of this embodiment, a protective case may comprise, e.g., at least 1, at least 2, at least 3, at least 4, at least 5, at least 6, at least 7, at least 8, at least 9, or at least 10 unsecurable openings. In yet other aspects of this embodiment, a protective case may comprise, e.g., at most 1, at most 2, at most 3, at most 4, at most 5, at most 6, at most 7, at most 8, at most 9, or at most 10 unsecurable openings. In yet other aspects of this embodiment, a protective case may comprise, e.g., about 1 to about 2, about 1 to about 3, about 1 to about 4, about 1 to about 5, about 1 to about 6, about 1 to about 7, about 1 to about 8, about 1 to about 9, about 1 to about 10, about 2 to about 3, about 2 to about 4, about 2 to about 5, about 2 to about 6, about 2 to about 7, about 2 to about 8, about 2 to about 9, about 2 to about 10, about 3 to about 4, about 3 to about 5, about 3 to about 6, about 3 to about 7, about 3 to about 8, about 3 to about 9, about 3 to about 10, about 4 to about 5, about 4 to about 6, about 4 to about 7, about 4 to about 8, about 4 to about 9, about 4 to about 10, about 5 to about 6, about 5 to about 7, about 5 to about 8, about 5 to about 9, about 5 to about 10, about 6 to about 7, about 6 to about 8, about 6 to about 9, or about 6 to about 10 unsecurable openings.

In some embodiments, a compartment comprising an unsecurable opening allows access to an interior space containing a coolant material or heating material, thereby allowing the coolant material or heating material to be inserted into or removed from the interior space. However, a coolant case may be designed so that the coolant material or heating material is not removable from an interior space of a compartment. Thus, in some embodiments, a compartment comprising an interior space containing a coolant material or heating material does not comprise or consist of an unsecurable opening. In some embodiments, a compartment comprising an unsecurable opening allows access to an interior space containing a portable electronic device, thereby allowing the device to be inserted into or removed from the interior space.

In some embodiments, the first unsecurable opening and second unsecurable are both accessible from the external surface of the protective case. In some embodiments, only one of a first unsecurable opening or a second unsecurable opening is accessible from the external surface of the protective case, the other securable opening being located internally. In these embodiments, the internal unsecurable opening is accessible only when the external securable opening is open see. In some embodiments, a first unsecurable opening and a second unsecurable opening are integrated into a single unsecurable opening.

In some embodiments, a first and/or second unsecurable opening are integrated into a top of a protective case. In some embodiments, a first and/or unsecurable opening a distinct component parts from the top a protective case.

Aspects of the present application disclose a securable opening. A securable opening enables access to an interior space disclosed herein and also provides a mechanism for a user to close or seal the interior space. Thus, a user may need to open a securable opening in order to insert or remove a coolant material, a heating material, and/or a portable electronic device from an interior space. In the closed position, a securable opening prevents a coolant material, a heating material, and/or a portable electronic device from being removed from an interior space. In one embodiment, a protective case may comprise a single securable opening, see, e.g., FIG. 5, 6, or 7. In another embodiment, a protective case may comprise a plurality of securable openings, see, e.g., FIG. 1, 2, 3, 4, or 8. In aspects of this embodiment, a protective case may comprise, e.g., 1, 2, 3, 4, 5, 6, 7, 8, 9, or 10 securable openings. In other aspects of this embodiment, a protective case may comprise, e.g., at least 1, at least 2, at least 3, at least 4, at least 5, at least 6, at least 7, at least 8, at least 9, or at least 10 securable openings. In yet other aspects of this embodiment, a protective case may comprise, e.g., at most 1, at most 2, at most 3, at most 4, at most 5, at most 6, at most 7, at most 8, at most 9, or at most 10 securable openings. In yet other aspects of this embodiment, a protective case may comprise, e.g., about 1 to about 2, about 1 to about 3, about 1 to about 4, about 1 to about 5, about 1 to about 6, about 1 to about 7, about 1 to about 8, about 1 to about 9, about 1 to about 10, about 2 to about 3, about 2 to about 4, about 2 to about 5, about 2 to about 6, about 2 to about 7, about 2 to about 8, about 2 to about 9, about 2 to about 10, about 3 to about 4, about 3 to about 5, about 3 to about 6, about 3 to about 7, about 3 to about 8, about 3 to about 9, about 3 to about 10, about 4 to about 5, about 4 to about 6, about 4 to about 7, about 4 to about 8, about 4 to about 9, about 4 to about 10, about 5 to about 6, about 5 to about 7, about 5 to about 8, about 5 to about 9, about 5 to about 10, about 6 to about 7, about 6 to about 8, about 6 to about 9, or about 6 to about 10 securable openings.

In some embodiments, a compartment comprising a securable opening allows access to an interior space containing a coolant material or heating material, thereby allowing the coolant material or heating material to be inserted into or removed from the interior space. However, a coolant case may be designed so that the coolant material or heating material is not removable from an interior space of a compartment. Thus, in some embodiments, a compartment comprising an interior space containing a coolant material or heating material does not comprise or consist of a securable opening. In some embodiments, a compartment comprising a securable opening allows access to an interior space containing a portable electronic device, thereby allowing the device to be inserted into or removed from the interior space.

A securable opening disclosed herein can be secured by any fastener mechanism that can keep the coolant material, heating material and/or portable electronic device contained in an interior space. Such mechanisms include, without exception a zip fastener such as a zipper, a snap fastener such as a “coin purse” mechanism, a hook and loop fastener such as VELCRO®, a prong fastener, a tongue and groove fastener such a ZIP-LOCK® mechanism, or a clip fastener. In aspects of this embodiment, a fastener mechanism used to secure a securable opening creates a water-retardant seal, water-resistant seal and/or water-proof seal.

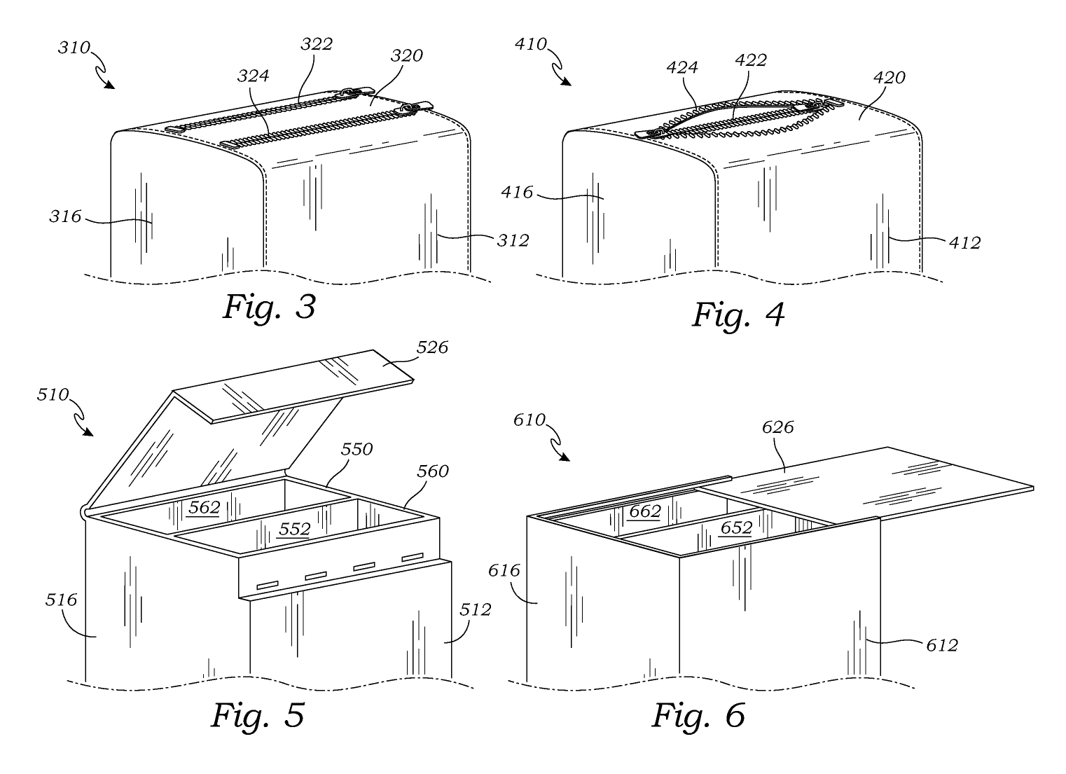

In some embodiments, the first securable opening and second securable are both accessible from the external surface of the protective case, see, e.g., FIG. 1, first securable opening 22 and second securable opening 24, FIG. 2, first securable opening 222 and second securable opening 224, or FIG. 3, first securable opening 322 and second securable opening 324. In some embodiments, only one of a first securable opening or a second securable opening is accessible from the external surface of the protective case, the other securable opening being located internally. In these embodiments, the internal securable opening is accessible only when the external securable opening is open see, e.g., FIG. 4, external securable opening 424 and internal securable opening 222, FIG. 7, external securable opening 724 and internal securable opening 722, or FIG. 8, external securable opening 826, first internal securable opening 822 and second internal securable opening 824. In some embodiments, a first securable opening and a second securable opening are integrated into a single securable opening that secures both the first and second interior space upon closure, see, e.g., FIG. 5 securable opening 526, or FIG. 6, securable opening 626.

In some embodiments, a first and/or second securable opening are integrated into a top of a protective case, such as, e.g., a zip fastener like a zipper or a hock and loop fastener like VELCRO® (see, e.g., 22 and 24 of FIG. 1A). In some embodiments, a first and/or securable opening a distinct component parts from the top a protective case, such as, e.g., a hinged lid (see, e.g., 222 and 224 of FIG. 2A).

The protective case disclosed herein can be designed with both unsecured and secured openings. In one embodiment, a protective case may comprise a single unsecurable opening and a single or plurality of securable openings. In one embodiment, a protective case may comprise a single securable opening and a single or plurality of unsecurable openings. In another embodiment, a protective case may comprise a plurality of securable openings and a plurality of unsecurable openings. In aspects of this embodiment, a protective case may comprise, e.g., 1, 2, 3, 4, 5, 6, 7, 8, 9, or 10 securable openings and, e.g., 1, 2, 3, 4, 5, 6, 7, 8, 9, or 10 unsecurable openings. In other aspects of this embodiment, a protective case may comprise, e.g., at least 1, at least 2, at least 3, at least 4, at least 5, at least 6, at least 7, at least 8, at least 9, or at least 10 securable openings and, e.g., at least 1, at least 2, at least 3, at least 4, at least 5, at least 6, at least 7, at least 8, at least 9, or at least 10 unsecurable openings. In yet other aspects of this embodiment, a protective case may comprise, e.g., at most 1, at most 2, at most 3, at most 4, at most 5, at most 6, at most 7, at most 8, at most 9, or at most 10 securable openings and, e.g., at most 1, at most 2, at most 3, at most 4, at most 5, at most 6, at most 7, at most 8, at most 9, or at most 10 unsecurable openings. In yet other aspects of this embodiment, a protective case may comprise, e.g., about 1 to about 2, about 1 to about 3, about 1 to about 4, about 1 to about 5, about 1 to about 6, about 1 to about 7, about 1 to about 8, about 1 to about 9, about 1 to about 10, about 2 to about 3, about 2 to about 4, about 2 to about 5, about 2 to about 6, about 2 to about 7, about 2 to about 8, about 2 to about 9, about 2 to about 10, about 3 to about 4, about 3 to about 5, about 3 to about 6, about 3 to about 7, about 3 to about 8, about 3 to about 9, about 3 to about 10, about 4 to about 5, about 4 to about 6, about 4 to about 7, about 4 to about 8, about 4 to about 9, about 4 to about 10, about 5 to about 6, about 5 to about 7, about 5 to about 8, about 5 to about 9, about 5 to about 10, about 6 to about 7, about 6 to about 8, about 6 to about 9, or about 6 to about 10 securable openings and, e.g., about 1 to about 2, about 1 to about 3, about 1 to about 4, about 1 to about 5, about 1 to about 6, about 1 to about 7, about 1 to about 8, about 1 to about 9, about 1 to about 10, about 2 to about 3, about 2 to about 4, about 2 to about 5, about 2 to about 6, about 2 to about 7, about 2 to about 8, about 2 to about 9, about 2 to about 10, about 3 to about 4, about 3 to about 5, about 3 to about 6, about 3 to about 7, about 3 to about 8, about 3 to about 9, about 3 to about 10, about 4 to about 5, about 4 to about 6, about 4 to about 7, about 4 to about 8, about 4 to about 9, about 4 to about 10, about 5 to about 6, about 5 to about 7, about 5 to about 8, about 5 to about 9, about 5 to about 10, about 6 to about 7, about 6 to about 8, about 6 to about 9, or about 6 to about 10 unsecurable openings.

A protective case comprising a front, a back, a securable opening and/or an unsecurable opening disclosed herein may comprise the same material or each may comprise different materials. The material used may be flexible or inflexible. For example, a useful flexible material would be a synthetic fabric like nylon or neoprene (FIG. 1, FIG. 7, and FIG. 8) whereas a useful inflexible material would be a plastic, metal, or metal alloy (FIG. 2). In some embodiments, protective case comprising a front, a back, a securable opening and/or an unsecurable opening disclosed herein comprises a material that effectively insults against the transfers thermal energy from a lower temperature to a higher temperature. In other embodiment, protective case comprising a front, a back, a securable opening and/or an unsecurable opening disclosed herein comprises a non-thermal conductive material. In yet other embodiment, protective case comprising a front, a back, a securable opening and/or an unsecurable opening disclosed herein comprises a material that provides thermal insulation. In an aspects of this embodiment, protective case comprising a material useful for making a front, a back, a securable opening and/or an unsecurable opening disclosed herein may be, e.g., a natural or synthetic fabric, such as, e.g., cotton or polyester, or a natural or synthetic plastic.

In an embodiment, protective case comprising a front, a back, a securable opening and/or an unsecurable opening disclosed herein comprises a material having a low thermal conductivity. In aspect of this embodiment, a front, a back, a securable opening and/or an unsecurable opening disclosed herein comprises a material having a thermal conductivity of, e.g., 0.0001 W/mK or less, 0.00025 W/mK or less, 0.0005 W/mK or less, 0.00075 W/mK or less, 0.001 W/mK or less, 0.0025 W/mK or less, 0.005 W/mK or less, 0.0075 W/mK or less, 0.01 W/mK or less, 0.025 W/mK or less, 0.05 W/mK or less, 0.075 W/mK or less, 0.1 W/mK or less, 0.25 W/mK or less, 0.5 W/mK or less, 0.75 W/mK or less, 1 W/mK or less, 2.5 W/mK or less, 5 W/mK or less, 7.5 W/mK or less, or 10 W/mK or less. In other aspects of this embodiments, protective case comprising a front, a back, a securable opening and/or an unsecurable opening disclosed herein comprises a material having a thermal conductivity in the range of, e.g., about 0.0001 W/mK to about 10 W/mK, about 0.0001 W/mK to about 5 W/mK, about 0.0001 W/mK to about 1 W/mK, about 0.0001 W/mK to about 0.5 W/mK, about 0.0001 W/mK to about 0.1 W/mK, about 0.0001 W/mK to about 0.05 W/mK, about 0.0001 W/mK to about 0.01 W/mK, about 0.0005 W/mK to about 10 W/mK, about 0.0005 W/mK to about 5 W/mK, about 0.0005 W/mK to about 1 W/mK, about 0.0005 W/mK to about 0.5 W/mK, about 0.0005 W/mK to about 0.1 W/mK, about 0.0005 W/mK to about 0.05 W/mK, or about 0.0005 W/mK to about 0.01 W/mK.

In an embodiment, protective case comprising a front, a back, a securable opening and/or an unsecurable opening disclosed herein comprises a material having a low heat transfer coefficient. In other aspect of this embodiment, a front, a back, a securable opening and/or an unsecurable opening disclosed herein comprises a material having a heat transfer coefficient of, e.g., 0.0001 W/Km² or less, 0.00025 W/Km² or less, 0.0005 W/Km² or less, 0.00075 W/Km² or less, 0.001 W/Km² or less, 0.0025 W/Km² or less, 0.005 W/Km² or less, 0.0075 W/Km² or less, 0.01 W/Km² or less, 0.025 W/Km² or less, 0.05 W/Km² or less, 0.075 W/Km² or less, 0.1 W/Km² or less, 0.25 W/Km² or less, 0.5 W/Km² or less, 0.75 W/Km² or less, 1 W/Km² or less, 2.5 W/Km² or less, 5 W/Km² or less, 7.5 W/Km² or less, or 10 W/Km² or less. In other aspects of this embodiments, protective case comprising a front, a back, a securable opening and/or an unsecurable opening disclosed herein comprises a material having a heat transfer coefficient in the range of, e.g., about 0.0001 W/mK to about 10 W/mK, about 0.0001 W/mK to about 5 W/mK, about 0.0001 W/mK to about 1 W/mK, about 0.0001 W/mK to about 0.5 W/mK, about 0.0001 W/mK to about 0.1 W/mK, about 0.0001 W/mK to about 0.05 W/mK, about 0.0001 W/mK to about 0.01 W/mK, about 0.0005 W/mK to about 10 W/mK, about 0.0005 W/mK to about 5 W/mK, about 0.0005 W/mK to about 1 W/mK, about 0.0005 W/mK to about 0.5 W/mK, about 0.0005 W/mK to about 0.1 W/mK, about 0.0005 W/mK to about 0.05 W/mK, or about 0.0005 W/mK to about 0.01 W/mK.

The interior surface of a divider, front, back and/or securable opening can be made of or coated with a water-proofing material that makes the material of the divider, back and/or securable opening impervious to a liquid for a period of time. As such, the water-proofing material makes the material of a divider, front, back and/or securable opening water-resistant. The purpose of the water-proofing material is to contain or restrict movement of any fluids condensing or building-up in an interior space so as to prevent exposure of the any these fluids to a compartment containing a portable electronic device. Non-limiting examples of such material include, natural or synthetic elastomeric material, like rubber, silicon, or neoprene.

In one embodiment, an interior surface of a divider, front, back and/or securable opening may comprise a water-proofing material that makes the material of a divider, front, back and/or securable opening water-resistant. In an aspect of this embodiment, a material of a divider, front, back and/or securable opening may also be a water-proofing material. In another aspect of this embodiment, a water-proofing material is a separate material that is place against the material of a divider, front, back and/or securable opening. In aspects of this embodiment, an interior surface of a divider, front, back and/or securable opening may comprise a material that restricts, e.g., at least 70%, at least 75%, at least 80%, at least 85%, at least 90%, at least 97%, or at least 99%, of fluid movement through the material of a divider, front, back and/or securable opening for a time of, e.g., at least 60 minutes, at least 90 minutes, at least 120 minutes, at least 150 minutes, at least 180 minutes, at least 210 minutes, at least 240 minutes, at least 300 minutes, at least 330 minutes, or at least 360 minutes. In other aspects, an interior surface of a divider, front, back and/or securable opening may comprise a material that restricts, e.g., about 70% to about 100%, about 75% to about 100%, about 80% to about 100%, about 85% to about 100%, about 90% to about 100%, about 70% to about 97%, about 75% to about 97%, about 80% to about 97%, about 85% to about 97 about 90% to about 97%, about 70% to about 95%, about 75% to about 95%, about 80% to about 95%, about 85% to about 95%, or about 90% to about 95%, of fluid movement through the material of a divider, front, back and/or securable opening for a time range of, e.g., about 60 minutes to about 120 minutes, about 60 minutes to about 180 minutes, about 60 minutes to about 240 minutes, about 60 minutes to about 300 minutes, or about 60 minutes to about 360 minutes.

In another embodiment, an interior surface of a divider, front, back and/or securable opening may be coated with a material that makes the material of a divider, front, back and/or securable opening water-resistant. In aspects of this embodiment, an interior surface of a divider, front, back and/or securable opening may be coated with a material that restricts at least 70%, at least 75%, at least 80%, at least 85%, at least 90%, at least 97%, or at least 99% of all fluid movement through the material of a divider, front, back and/or securable opening for a time of, e.g., at least 60 minutes, at least 90 minutes, at least 120 minutes, at least 150 minutes, at least 180 minutes, at least 210 minutes, at least 240 minutes, at least 300 minutes, at least 330 minutes, or at least 360 minutes. In other aspects, an interior surface of a divider, front, back and/or securable opening may be coated with a material that restricts, e.g., about 70% to about 100%, about 75% to about 100%, about 80% to about 100%, about 85% to about 100%, about 90% to about 100%, about 70% to about 97%, about 75% to about 97%, about 80% to about 97%, about 85% to about 97 about 90% to about 97%, about 70% to about 95%, about 75% to about 95%, about 80% to about 95%, about 85% to about 95%, or about 90% to about 95%, of fluid movement through the material of a divider, front, back and/or securable opening for a time range of, e.g., about 60 minutes to about 120 minutes, about 60 minutes to about 180 minutes, about 60 minutes to about 240 minutes, about 60 minutes to about 300 minutes, or about 60 minutes to about 360 minutes.

A front disclosed herein may comprise a translucent material or a transparent material. A translucent or a transparent material is used generally to enable a user to view the portable electronic device placed in the second interior space. Such viewing enables the user to see features on the portable electronic device without the need to remove the device from the interior compartment of the protective case. See 13 of FIGS. 1C and 213 of FIG. 2C.

Aspects of the present specification disclose a protective case for a portable electronic device comprising a first compartment disclosed herein and one or more attachment points. An attachment point is any structure that is useful in securing the protective case to a portable electronic device. Non-limiting examples include a prong fastener, a tongue and groove fastener, a clip fastener, a snap fastener, or a hook and loop fastener. In some embodiments, an attachment device is affixed to the protective case in order to allow the user to attach the protective case to an article of clothing. For example, without limitation, a clip may be affixed to the protective case which will enable the user to attach the protective case to a belt, a waist band of a pants or shirt, of a strap from a backpack, purse, or other carrying case.

In an aspect of this embodiment, a protective case for a portable electronic device comprises a single attachment point. In another aspect of this embodiment, a protective case for a portable electronic device comprises a plurality of attachment points. In aspects of this embodiment, a protective case for a portable electronic device comprises 2, 3, 4, 5, 6, 7, 8, 9, or 10 attachment points. In other aspects of this embodiment, a protective case for a portable electronic device comprises about 2 to about 10, about 3 to about 10, about 4 to about 10, about 5 to about 10, about 2 to about 8, about 3 to about 8, about 4 to about 8, or about 5 to about 8 attachment points.

Aspects of the present specification also disclose a kit comprising a protective case as disclosed herein and a coolant material and/or heating material disclosed herein. In an aspect of this embodiment, a kit disclosed herein comprising a protective case disclosed herein and a coolant material disclosed herein. In another aspect of this embodiment, a kit disclosed herein comprising a protective case disclosed herein and a heating material disclosed herein. In yet another aspect of this embodiment, a kit disclosed herein comprising a protective case disclosed herein, a coolant material disclosed herein and or heating material disclosed herein.

A kit disclosed herein may include instructional information. Instructional information includes, without limitation, instructions, labels or inserts. Instructional information include “printed matter,” e.g., paper or cardboard, or separate or affixed to a component, a kit or packing material (e.g., a box). Instructional information can additionally include a computer readable medium, such as a disk (e.g., hard disk, flash memory), optical disk such as CD- or DVD-ROM/RAM, DVD, MP3, magnetic tape, or an electrical storage media such as RAM and ROM or hybrids of these such as magnetic/optical storage media, FLASH media or memory type cards. Instructional information may include identifying information of one or more components therein, manufacturer information, lot numbers, manufacturer location and date, warning information, assembly instructions, and use instructions.

Aspects of the present invention can also be described as follows:
1. A protective case for a portable electronic device, the protective case comprising a first compartment, a second compartment, a divider, and a first securable opening, wherein the first compartment comprises a front and the divider, wherein the divider and the front define a first interior space configured to contain a portable electronic device;
   wherein the second compartment comprises a back and the divider, wherein the divider and the back define a second interior space configured to contain a coolant material and/or a heating material; and wherein the divider and the back comprise a water-resistant material;
   wherein the divider comprises a thermal conductive material; and
   wherein the first securable opening covers the first interior space when in the closed position.
2. The protective case according to embodiment 2, wherein the front, the back, and the first securable opening are composed of identical material.
3. The protective case according to embodiment 3, wherein the identical material is a material that provides thermal insulation.
4. The protective case according to any one of embodiments 1-3, wherein the front comprises a transparent material.
5. The protective case according to any one of embodiments 1-4, wherein the first securable opening is secured by a zip fastener, a snap fastener, a hook and loop fastener, a prong fastener, a tongue and groove fastener, or a clip fastener.
6. The protective case according to any one of embodiments 1-5, wherein the second compartment further comprises a second securable opening or a first unsecurable opening.
7. The protective case according to embodiment 6, wherein the front, the back, the first securable opening and the second securable opening or the first unsecurable opening are composed of identical material.
8. The protective case according to embodiment 7, wherein the identical material is a material that provides thermal insulation.
9. The protective case according to any one of embodiments 6-8, wherein the second securable opening is secured by a zip fastener, a snap fastener, a hook and loop fastener, a prong fastener, a tongue and groove fastener, or a clip fastener.
10. A protective case for a portable electronic device, the protective case comprising a first compartment, a second compartment, a divider, and a first securable opening, wherein the first compartment comprises a front and the divider, wherein the divider and the front define a first interior space configured to contain a portable electronic device;
   wherein the second compartment comprises a back and a second securable opening, wherein the divider, the back and the second securable opening define a second interior space configured to contain a coolant material and/or a heating material; and wherein the divider, the back and the second securable opening comprise a water-resistant material;
   wherein the divider comprises a thermal conductive material; and
   wherein the first securable opening covers the first interior space when in the closed position.
11. The protective case according to embodiment 10, wherein the front, the back, the first securable opening and the second securable opening are composed of identical material.
12. The protective case according to embodiment 11, wherein the identical material is a material that provides thermal insulation.
13. The protective case according to any one of embodiments 10-12, wherein the front comprises a transparent material.
14. The protective case according to any one of embodiments 10-13, wherein the first securable opening is secured by a zip fastener, a snap fastener, a hook and loop fastener, a prong fastener, a tongue and groove fastener, or a clip fastener.
15. The protective case according to any one of embodiments 10-14, wherein the second securable opening is secured by a zip fastener, a snap fastener, a hook and loop fastener, a prong fastener, a tongue and groove fastener, or a clip fastener.
16. The protective case according to any one of embodiments 1-15, wherein the divider further comprise a thermal material.
17. A protective case for a portable electronic device, the protective case comprising a first compartment, a second compartment, a third compartment, and a first securable opening,
   wherein the first compartment comprises a front and a first divider, wherein the first divider and the front define a first interior space configured to contain a coolant material and/or a heating material; and wherein the first divider and the front comprise a water-resistant material;
   wherein the second compartment comprises a back and a second divider, wherein the second divider and the back define a second interior space configured to contain a coolant material and/or a heating material; and wherein the second divider and the back comprise a water-resistant material;
   wherein the third compartment comprises the first divider and the second divider, wherein the first divider and the second divider define a third interior space configured to contain a portable electronic device; and
   wherein the first and second dividers comprises a thermal conductive material; and
   wherein the first securable opening covers the third interior space when in the closed position.
18. The protective case according to embodiment 17, wherein the front, the back, and the first securable opening are composed of identical material.
19. The protective case according to embodiment 18, wherein the identical material is a material that provides thermal insulation.
20. The protective case according to any one of embodiments 17-19, wherein the first securable opening is secured by a zip fastener, a snap fastener, a hook and loop fastener, a prong fastener, a tongue and groove fastener, or a clip fastener.
21. The protective case according to any one of embodiments 17-20, wherein the first compartment further comprises a second securable opening or a first unsecurable opening.
22. The protective case according to embodiment 21, wherein the front, the back, the first securable opening and the second securable opening or the first unsecurable opening are composed of identical material.
23. The protective case according to embodiment 22, wherein the identical material is a material that provides thermal insulation.
24. The protective case according to any one of embodiments 21-23, wherein the second securable opening is secured by a zip fastener, a snap fastener, a hook and loop fastener, a prong fastener, a tongue and groove fastener, or a clip fastener.
25. The protective case according to any one of embodiments 17-24, wherein the second compartment further comprises a third securable opening or a second unsecurable opening.
26. The protective case according to embodiment 25, wherein the front, the back, the first securable opening, the second securable opening, and the third securable opening or the second unsecurable opening are composed of identical material.
27. The protective case according to embodiment 26, wherein the identical material is a material that provides thermal insulation.
28. The protective case according to any one of embodiments 25-27, wherein the second securable opening is secured by a zip fastener, a snap fastener, a hook and loop fastener, a prong fastener, a tongue and groove fastener, or a clip fastener.
29. The protective case according to any one of embodiments 17-28, wherein the first divider further comprise a thermal material.
30. The protective case according to any one of embodiments 17-29, wherein the second divider further comprise a thermal material.
31. A protective case for a portable electronic device, the protective case comprising a first compartment, a second compartment, a third compartment and a third securable opening,
   wherein the first compartment comprises a front, a first divider, and a first securable opening, wherein the first divider, the front and the first securable opening define a first interior space configured to contain a coolant material and/or a heating material; and wherein the first divider, the front and the first securable opening comprise a water-resistant material;
   wherein the second compartment comprises a back, a second divider, and a second securable opening, wherein the second divider, the back and the second securable opening define a second interior space configured to contain a coolant material and/or a heating material; and wherein the second divider, the back and the second securable opening comprise a water-resistant material;
   wherein the third compartment comprises a first divider and a second divider, wherein the first divider and the second divider define a third interior space configured to contain a portable electronic device;
   wherein the first and second dividers comprises a thermal conductive material; and
   wherein the third securable opening covers the third interior space when in the closed position.
32. The protective case according to embodiment 31, wherein the front, the back, the first securable opening, the second securable opening, and the third securable opening are composed of identical material.
33. The protective case according to embodiment 32, wherein the identical material is a material that provides thermal insulation.
34. The protective case according to any one of embodiments 31-33, wherein the front comprises a transparent material.
35. The protective case according to any one of embodiments 31-34, wherein the first securable opening is secured by a zip fastener, a snap fastener, a hook and loop fastener, a prong fastener, a tongue and groove fastener, or a clip fastener.
36. The protective case according to any one of embodiments 31-35, wherein the second securable opening is secured by a zip fastener, a snap fastener, a hook and loop fastener, a prong fastener, a tongue and groove fastener, or a clip fastener.
37. The protective case according to any one of embodiments 31-36, wherein the third securable opening is secured by a zip fastener, a snap fastener, a hook and loop fastener, a prong fastener, a tongue and groove fastener, or a clip fastener.
38. The protective case according to any one of embodiments 31-37, wherein the first divider further comprise a thermal material.
39. The protective case according to any one of embodiments 31-38, wherein the second divider further comprise a thermal material.
40. A protective case for a portable electronic device, the protective case comprising a plurality of compartments and a first securable opening,
   wherein the plurality of compartment comprises three or more compartments wherein a first compartment of the plurality of compartment comprises a front and a first divider, wherein the first divider and the front define a first interior space configured to contain a coolant material and/or a heating material; and wherein the first divider and the front comprise a water-resistant material;
   wherein a second compartment of the plurality of compartment comprises a back and a second divider, wherein the second divider and the back define a second interior space configured to contain a coolant material and/or a heating material; and wherein the second divider and the back comprise a water-resistant material;
   wherein the third compartment comprises the first divider and the second divider, wherein the first divider and the second divider define a third interior space configured to contain a portable electronic device; and
   wherein the first and second divider comprises a thermal conductive material; and
   wherein the first securable opening covers the third interior space when in the closed position.
41. The protective case according to embodiment 40, wherein the front, the back, and the first securable opening are composed of identical material.
42. The protective case according to embodiment 41, wherein the identical material is a material that provides thermal insulation.
43. The protective case according to any one of embodiments 40-42, wherein the first securable opening is secured by a zip fastener, a snap fastener, a hook and loop fastener, a prong fastener, a tongue and groove fastener, or a clip fastener.
44. The protective case according to any one of embodiments 40-43, wherein the first compartment further comprises a second securable opening or a first unsecurable opening.
45. The protective case according to embodiment 44, wherein the front, the back, the first securable opening and the second securable opening or the first unsecurable opening are composed of identical material.
46. The protective case according to embodiment 45, wherein the identical material is a material that provides thermal insulation.
47. The protective case according to any one of embodiments 44-46, wherein the second securable opening is secured by a zip fastener, a snap fastener, a hook and loop fastener, a prong fastener, a tongue and groove fastener, or a clip fastener.
48. The protective case according to any one of embodiments 55-47, wherein the second compartment further comprises a third securable opening or a second unsecurable opening.
49. The protective case according to embodiment 48, wherein the front, the back, the first securable opening, the second securable opening, and the third securable opening or the second unsecurable opening are composed of identical material.
50. The protective case according to embodiment 49, wherein the identical material is a material that provides thermal insulation.
51. The protective case according to any one of embodiments 48-50, wherein the second securable opening is secured by a zip fastener, a snap fastener, a hook and loop fastener, a prong fastener, a tongue and groove fastener, or a clip fastener.
52. A protective case for a portable electronic device, the protective case comprising a plurality of compartments and a first securable opening,
   wherein the plurality of compartment comprises three or more compartments
   wherein a first compartment of the plurality of compartment comprises a front, a first divider, and a first securable opening, wherein the first divider, the front and the first securable opening define a first interior space configured to contain a coolant material and/or a heating material; and wherein the first divider, the front and the first securable opening comprise a water-resistant material;
   wherein a second compartment of the plurality of compartment comprises a back, a second divider, and a second securable opening, wherein the second divider, the back and the second securable opening define a second interior space configured to contain a coolant material and/or a heating material; and wherein the second divider, the back and the second securable opening comprise a water-resistant material;
   wherein the third compartment comprises the first divider and the second divider, wherein the first divider and the second divider define a third interior space configured to contain a portable electronic device; and
   wherein the first and second dividers comprises a thermal conductive material; and
   wherein the first securable opening covers the third interior space when in the closed position.
53. The protective case according to embodiment 52, wherein the front, the back, the first securable opening, the second securable opening, and the third securable opening are composed of identical material.
54. The protective case according to embodiment 53, wherein the identical material is a material that provides thermal insulation.
55. The protective case according to any one of embodiments 52-54, wherein the front comprises a transparent material.
56. The protective case according to any one of embodiments 52-55, wherein the first securable opening is secured by a zip fastener, a snap fastener, a hook and loop fastener, a prong fastener, a tongue and groove fastener, or a clip fastener.
57. The protective case according to any one of embodiments 52-56, wherein the second securable opening is secured by a zip fastener, a snap fastener, a hook and loop fastener, a prong fastener, a tongue and groove fastener, or a clip fastener.
58. The protective case according to any one of embodiments 52-57, wherein the third securable opening is secured by a zip fastener, a snap fastener, a hook and loop fastener, a prong fastener, a tongue and groove fastener, or a clip fastener.
59. The protective case according to any one of embodiments 52-58, wherein the plurality of compartments comprise at least 3, at least 4, at least 5, at least 6, at least 7, at least 8, at least 9, or at least 10 compartments for a coolant material and/or a heating material.
60. The protective case according to any one of embodiments 52-59, wherein the plurality of compartments comprise at least 3, or at least 4 compartments for a portable electronic device.
61. The protective case according to any one of embodiments 40-60, wherein the first divider further comprise a thermal material.
62. The protective case according to any one of embodiments 40-61, wherein the second divider further comprise a thermal material.
63. A protective case for a portable electronic device, the protective case comprising a first compartment configure to contain a coolant material and/or a heating material and one or more attachment points
   wherein the first compartment comprises a front comprising of a conductive material, a back comprising a non-conductive material, and a securable opening;
   wherein the front, the back and the securable opening define an interior space; and
   wherein the front, the back and the securable opening defining the interior space comprise a water-resistant material.
64. The protective case according to any one of embodiments 1-63, wherein the portable electronic device is a personal digital assistant (PDAs), a smartphone, a mobile phone, a satellite phone, a cellular phone, a tablet, a computer, a pager, a music player, a MP3 player, a media player, a digital camera, a video camera, a bar code scanner, a global positioning system (GPS), and a portable game console.
65. A kit comprising a protective case as defined in any one of embodiments 1-64 and a coolant material and/or a heating material.
66. The kit according to embodiment 65, wherein the coolant material is an activatable coolant material or a non-activatable coolant material.
67. The kit according to embodiment 65, wherein the heating material is an activatable heating material or a non-activatable heating material.
68. The kit according to any one of embodiment 65-67, further comprising instructional material.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only, and is not intended to limit the scope of the present invention, which is defined solely by the claims. Accordingly, the present invention is not limited to that precisely as shown and described.

Certain embodiments of the present invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques. Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

The terms “a,” “an,” “the” and similar referents used in the context of describing the present invention (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the present invention so claimed are inherently or expressly described and enabled herein.

All patents, patent publications, and other publications referenced and identified in the present specification are individually and expressly incorporated herein by reference in their entirety for the purpose of describing and disclosing, for example, the compositions and methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

1. A protective case for a portable electronic device, the protective case comprising a first compartment, a second compartment, a third compartment, and a first securable opening,
wherein the first compartment comprises a front and a first divider, wherein the first divider and the front define a first interior space configured to contain a coolant material and/or a heating material; and wherein the first divider and the front comprise a water-resistant material;
wherein the second compartment comprises a back and a second divider, wherein the second divider and the back define a second interior space configured to contain a coolant material and/or a heating material; and wherein the second divider and the back comprise a water-resistant material;
wherein the third compartment comprises the first divider and the second divider, wherein the first divider and the second divider define a third interior space configured to contain a portable electronic device; and
wherein the first and second dividers comprises a thermal conductive material; and
wherein the first securable opening covers the third interior space when in the closed position.

2. The protective case according to claim 1, wherein the front, the back, and the first securable opening are composed of identical material.

3. The protective case according to claim 2, wherein the identical material is a material that provides thermal insulation.

4. The protective case according to claim 1, wherein the first securable opening is secured by a zip fastener, a snap fastener, a hook and loop fastener, a prong fastener, a tongue and groove fastener, or a clip fastener.

5. The protective case according to claim 1, wherein the first compartment does not comprise a second securable opening.

6. The protective case according to claim 1, wherein the first compartment further comprises a second securable opening.

7. The protective case according to claim 6, wherein the front, the back, the first securable opening and the second securable opening are composed of identical material.

8. The protective case according to claim 7, wherein the identical material is a material that provides thermal insulation.

9. The protective case according to claim 6, wherein the second securable opening is secured by a zip fastener, a snap fastener, a hook and loop fastener, a prong fastener, a tongue and groove fastener, or a clip fastener.

10. The protective case according to claim 1, wherein the second compartment does not comprise a third securable opening.

11. The protective case according to claim 1, wherein the second compartment further comprises a third securable opening.

12. The protective case according to claim 11, wherein the front, the back, the first securable opening, the second securable opening, and the third securable opening are composed of identical material.

13. The protective case according to claim 12, wherein the identical material is a material that provides thermal insulation.

14. The protective case according to claim 11, wherein the second securable opening is secured by a zip fastener, a snap fastener, a hook and loop fastener, a prong fastener, a tongue and groove fastener, or a clip fastener.

15. The protective case according to claim 1, wherein the first divider further comprise a thermal material.

16. The protective case according to claim 1, wherein the second divider further comprise a thermal material.

17. A kit comprising a protective case as defined in claim 1 and a coolant material and/or a heating material.

18. The kit according to claim 17, wherein the coolant material is an activatable coolant material or a non-activatable coolant material.

19. The kit according to claim 17, wherein the heating material is an activatable heating material or a non-activatable heating material.

20. A protective case for a portable electronic device, the protective case comprising a first compartment, a second compartment, a third compartment, and a first securable opening,
wherein the first compartment comprises a front, a first divider and a first coolant material, wherein the first divider and the front define a first interior space containing the first coolant material; and wherein the first divider and the front comprise a water-resistant material;
wherein the second compartment comprises a back, a second divider and a second coolant material, wherein the second divider and the back define a second interior space containing the second coolant material; and wherein the second divider and the back comprise a water-resistant material;
wherein the third compartment comprises the first divider and the second divider, wherein the first divider and the second divider define a third interior space configured to contain a portable electronic device; and
wherein the first and second dividers comprises a thermal conductive material; and
wherein the first securable opening covers the third interior space when in the closed position and is secured using a hook and loop fastener.
